(19) United States
(12) Patent Application Publication
(10) Pub. No.: US 2026/0340759 A1
(43) Pub. Date: Oct. 29, 2026

(54) KEY-VALUE CACHE DATA CONVERSION METHOD AND ELECTRONIC DEVICE

(71) Applicant: Lenovo (Beijing) Limited, Beijing (CN)

(72) Inventors: Xiaolei HAN, Beijing (CN); Jun LIU, Beijing (CN); Xin ZHOU, Beijing (CN)

(21) Appl. No.: 19/647,036

(22) Filed: Apr. 14, 2026

(30) Foreign Application Priority Data
Apr. 23, 2025 (CN) 202510515247.5

(51) Int. Cl. G06T 1/20

(52) U.S. Cl. CPC G06T 1/20

(57) ABSTRACT

A key-value cache data conversion method includes obtaining source key-value cache data extracted from a source graphics processing unit (GPU), and partitioning and adjusting data format of the source key-value cache data based on mapping information between the source GPU and a target GPU to obtain target key-value cache data that matches processing capability of the target GPU.

### CROSS-REFERENCES TO RELATED APPLICATION

This application claims priority to Chinese Patent Application No. 202510515247.5 filed on Apr. 23, 2025, the entire content of which is incorporated herein by reference.

### FIELD OF TECHNOLOGY

The present disclosure relates to the field of electronic technology and, more specifically, to a key-value cache data conversion method and an electronic device.

### BACKGROUND

With the rapid advancement of artificial intelligence and deep learning technologies, particularly the application of large-scale language models based on the Transformer architecture across a wide range of tasks, the demand for high-performance computing hardware is steadily increasing. As core hardware for deep learning, graphics processing units (GPUs) are widely used in data centers, edge devices, and hybrid clouds. However, differences in architecture, interfaces, and computing units in GPUs from various vendors (such as Nvidia, AMD, etc.) have brought data compatibility issues to the forefront in heterogeneous computing environments, particularly in the transfer of key-value cache (KVCache) data within Transformer models. During Transformer inference, KVCache data is stored as tensors in the GPU memory (e.g., [batch_size, num_heads, seq_len, head_dim]). Since inference tasks may span multiple nodes or require migration across different hardware, such as from cloud-based NVIDIA GPUs to edge-based AMD GPUs, cross-device transfer of the KVCache becomes a necessity. There is a need to improve the conversion efficiency of KVCache data to address compatibility issues caused by data exchange between different GPU models.

### SUMMARY

One aspect of this disclosure provides a key-value cache data conversion method. The method includes obtaining source key-value cache data extracted from a source graphics processing unit (GPU), and partitioning and adjusting data format of the source key-value cache data based on mapping information between the source GPU and a target GPU to obtain target key-value cache data that matches processing capability of the target GPU.

Another aspect of this disclosure provides a key-value cache data conversion device. The device includes an acquisition unit, and a partitioning and format adjustment module. The acquisition module is configured to obtain source key-value cache data extracted from a source graphics processing unit (GPU). The partitioning and format adjustment module is configured to partition and adjust data format of the source key-value cache data based on mapping information between the source GPU and a target GPU to obtain target key-value cache data that matches processing capability of the target GPU.

Another aspect of this disclosure provides an electronic device. The electronic device includes one or more processors and a memory storing one or more computer program instructions. When executed by the one of more processors, the computer program instructions cause the one or more processors to perform the key-value cache data conversion method in the present disclosure.

### BRIEF DESCRIPTION OF THE DRAWINGS

FIG. 1 is a flowchart of a key-value cache data conversion method according to some embodiments of the present disclosure.

FIG. 2A is a flowchart of the key-value cache data conversion method according to some embodiments of the present disclosure.

FIG. 2B is a schematic diagram of a method for partitioning a KVCache tensor according to some embodiments of the present disclosure.

FIG. 2C is a flowchart of the key-value cache data conversion method according to some embodiments of the present disclosure.

FIG. 3 is a flowchart of a method for updating a device mapping table according to some embodiments of the present disclosure.

FIG. 4A is a schematic diagram of a newly added module for data conversion according to some embodiments of the present disclosure.

FIG. 4B is a flowchart of the key-value cache data conversion method according to some embodiments of the present disclosure.

FIG. 5 is a schematic diagram of a key-value cache data conversion device according to some embodiments of the present disclosure.

FIG. 6 is a schematic diagram of an electronic device according to some embodiments of the present disclosure.

### DETAILED DESCRIPTION

To make the purposes, technical solutions, and advantages of the present disclosure clearer, the present disclosure is described in detail in connection with the accompanying drawings. The described embodiments should not be considered to limit the scope of the present disclosure. All other embodiments obtained by those skilled in the art without creative efforts are within the scope of the present disclosure.

In the following description, the term “some embodiments” describes a subset of all possible embodiments. “Some embodiments” can be a same subset or different subsets of all possible embodiments and can be combined with each other when there is no conflict.

In the following description, the terms “first,” “second,” and “third” are merely used to distinguish similar objects and do not represent a specific order. The terms “first,” “second,” and “third” can be interchanged in a specific sequence or order. Thus, embodiments of the present disclosure can be implemented in an order other than the order shown or described here.

Unless otherwise defined, all technical and scientific terms of the present disclosure have the same meanings as commonly understood by those skilled in the art. The terms used in the present disclosure are merely for the purpose of describing embodiments of the present disclosure and are not intended to limit the present disclosure.

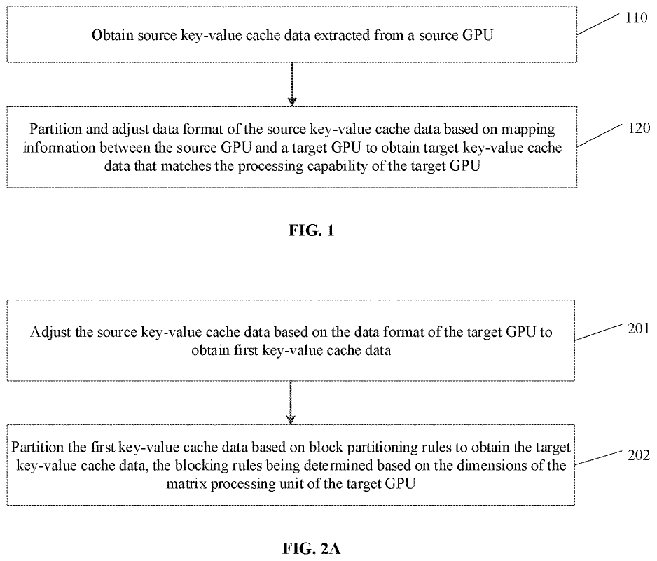

An embodiment of the present disclosure provides a key-value cache data conversion method. FIG. 1 is a flowchart of a key-value cache data conversion method according to some embodiments of the present disclosure. The method will be described in detail below.

101, obtaining source key-value cache data extracted from a source graphics processing unit (GPU).

In some embodiments, the source GPU and the target GPU may be heterogeneous GPUs.

Key-value cache (KVCache) is a technique widely used in natural language processing (NLP) models, particularly in generative models based on the Transformer architecture (such as the GPT series), to optimize inference efficiency and reduce computational and memory overhead. KVCache data refers to the cached data used during the inference process of Transformer models to store the key and value matrices within the self-attention mechanism. The key cache is a tensor with the shape of (batch_size, num_heads, seq_len, k_dim), used to store the key matrix. The value cache is a tensor with the shape of (batch_size, num_heads, seq_len, v_dim), used to store the value matrix. The key matrix represents the feature information for each position in the input sequence and is used to calculate attention weights. The value matrix represents the specific content information at each position within the input sequence, and is used to perform a weighted sum based on the attention weights.

During implementation, for example, when the source GPU transfers cached source key-value data to the heterogeneous target GPU to continue inference, the KVCache data may be extracted from the source GPU and its original metadata may be recorded. The original metadata may include tensor dimensions ([batch_size, num_heads, seq_len, head_dim]), data type (e.g., FP16 or FP32), and the hardware context at the time of generation (e.g., CUDA version, thread block configuration).

120, based on mapping information between the source GPU and the target GPU, partitioning and adjusting the data format of the source key-value cache data to obtain target key-value cache data that matches the processing capabilities of the target GPU.

The mapping information may consist of details of the hardware and processing capabilities corresponding to GPUs of various specifications. In some embodiments, the mapping information may include information of at least one of: the matrix processing unit dimensions, the cache block size, the memory alignment requirements, the floating-point precision support, and the optimal block size. The optimal block size may be determined based on the dimensions of the matrix processing unit. For example, if the matrix processing unit size is 16×16 (tensor core), the corresponding optimal block size may be 32×32; if the matrix processing unit size is 32×32 (tensor core), the corresponding optimal block size may be 64×64. In some embodiments, the tensor core may be the hardware unit designed to accelerate matrix operations in deep learning.

Consistent with the present disclosure, the source key-value cache data extracted from the source GPU is obtained; then, based on the mapping information between the source and target GPUs, the source key-value cache data undergoes partitioning and data format adjustment to obtain target key-value cache data that matches the processing capabilities of the target GPU. In this way, the blocking strategy aligns with the hardware acceleration units of the target GPU, which achieves standardization and decoupling, thereby enhancing inference performance. The data conversion does not rely on the underlying implementations of the source GPU (such as video memory pointers); instead, it processes only generic logical data structures, thereby breaking the dependency on the source GPU hardware. In this way, the data transfer compatibility between GPUs of differing architectures is enhanced, which effectively boosts the data conversion efficiency.

In some embodiments, the mapping information may include the data format information and the matrix processing unit dimensions.

The data format of a GPU may be related to the manner in which data is represented and processed. In some embodiments, the data format information may include at least one of: endianness, floating-point precision, and memory alignment.

Endianness refers to the storage order of multi-byte data (such as 16-bit or 32-bit integers) in memory. The endianness may include at least big-endian and little-endian. Big-endian refers to storing the most significant byte at a lower memory address (e.g., 0x1234 is stored as 12 34); little-endian refers to storing the least significant byte at the lower memory address (e.g., 0x1234 is stored as 34 12).

Floating-point precision refers to the number of significant digits and the range available when a floating-point number represents a fractional value, and is determined by the bit width. The floating-point precision may include at least single precision (32-bit), half precision (16-bit), and double precision (64-bit).

Memory alignment refers to the requirement that the storage location of data in memory needs to satisfy hardware alignment requirements in order to enhance access efficiency. The alignment requirements may include alignment by data type (e.g., aligning a 4-byte integer to a 4-byte boundary). In some cases, image data may require alignment by row or block (e.g., to a 32-byte cache line).

In some embodiments, GPUs of different specifications may differ with respect to at least one of the data format parameters described above. That is, the endianness, floating-point precision, and memory alignment.

The size of a matrix processing unit (MPU) refers to the dimensions of the matrices it is capable of processing, or its parallel computing capacity. At the logical level, the size of the MPU refers to the dimensions of the matrices that the MPU is capable of handling, such as 16×16, 32×32, 64×64, etc.

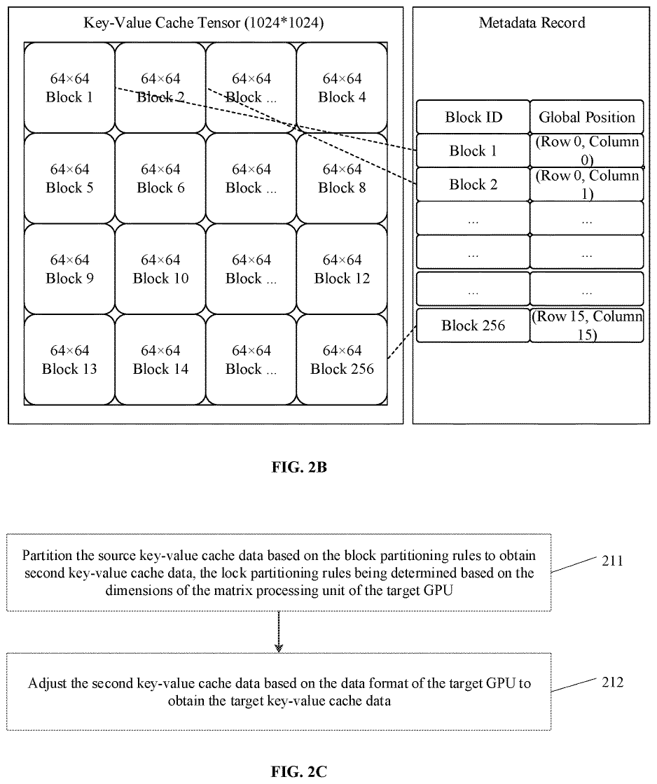

In some embodiments, the process at 120 can be implemented through the following steps shown in FIG. 2A.

201, adjusting the source key-value cache data based on the data format of the target GPU to obtain first key-value cache data.

During implementation, the data format of the target MPU may be determined first, for example, the endianness of the target GPU uses big-endian, the memory alignment requirement is 32-byte, and the floating-point precision supports FP32. Subsequently, the source key-value cache data can be adjusted to conform to the data format of the target GPU.

202, performing block partitioning on the first key-value cache data based on block partitioning rules to obtain the target key-value cache data, the block partitioning rules being determined based on the dimensions of the MPU of the target GPU.

In some embodiments, the block partitioning rules may be determined based on the dimensions of the target GPU's MPU. For example, given that the MPU size of the target GPU is 16×16, the optimal block size can be determined to be 32×32.

FIG. 2B is a schematic diagram of a method for partitioning a KVCache tensor according to some embodiments of the present disclosure. As shown in FIG. 2B, a 1024×1024 KVCache tensor is partitioned into 256 sub-tensors of size 64×64, an identifier is assigned to each sub-tensor, and metadata records are generated based on the identity document (ID) corresponding to each sub-tensor. For example, a sub-tensor labeled “Block 1” may correspond to a recorded global position of “Row 0, Column 0”.

Consistent with the present disclosure, the source key-value cache data is adjusted based on the data format of the target GPU to obtain the first key-value cache data; then, the first key-value cache data is partitioned into blocks based on block partitioning rules to obtain target key-value cache data. In this way, the obtained target key-value cached data conforms both to the data format of the target GPU and to the dimensions of the target GPU's MPU. This enables the target key-value cache data to align with the computational requirements of the target GPU, thereby achieving standardization and decoupling, and ultimately enhancing inference performance.

In some embodiments, the process at 120 can be implemented through the following steps shown in FIG. 2C.

211, performing block partitioning on the source key-value cache data based on the block partitioning rules to obtain second key-value cache data, the block partitioning rules being determined based on the dimensions of the MPU of the target GPU.

In some embodiments, the block partitioning rules may be determined based on the dimensions of the target GPU's MPU. For example, given that the MPU size of the target GPU is 16×16, the optimal block size can be determined to be 32×32.

In some embodiments, after the optimal block size has been determined, the source key-value cache data can be partitioned into blocks based on block partitioning rules to obtain the second key-value cache data.

FIG. 2B is a schematic diagram of a method for partitioning a KVCache tensor according to some embodiments of the present disclosure. As shown in FIG. 2B, a 1024×1024 KVCache tensor is partitioned into 256 sub-tensors of size 64×64, an identifier is assigned to each sub-tensor, and metadata records are generated based on the identity document (ID) corresponding to each sub-tensor. For example, a sub-tensor labeled “Block 1” may correspond to a recorded global position of “Row 0, Column 0”.

212, adjusting the source key-value cache data based on the data format of the target GPU to obtain the target key-value cache data.

After the block partitioning, the data format of the target GPU can be determined. For example, the endianness of the target GPU uses big-endian, the memory alignment requirement is 32-byte, and the floating-point precision supports FP32. Subsequently, the source key-value cache data can be adjusted to conform to the data format of the target GPU.

Consistent with the present disclosure, the source key-value cache data is partitioned into blocks based on block partitioning rules to obtain the second key-value cache data; then, the second key-value cache data is adjusted based on the data format of the target GPU to obtain target key-value cache data. In this way, the obtained target key-value cached data conforms both to the data format of the target GPU and to the dimensions of the target GPU's MPU. This enables the target key-value cache data to align with the computational requirements of the target GPU, thereby achieving standardization and decoupling, and ultimately enhancing inference performance.

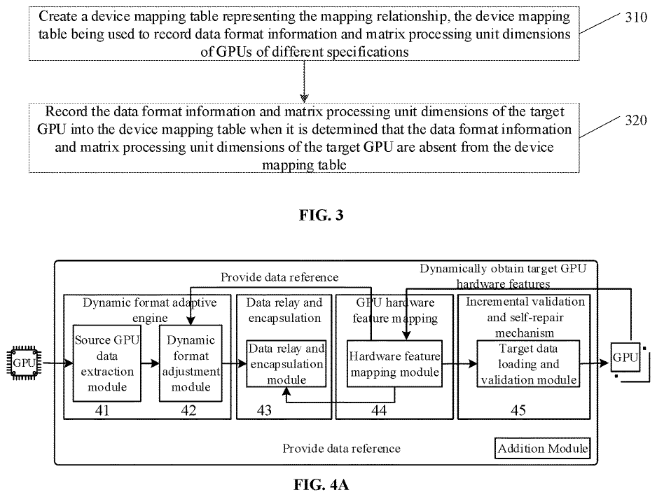

An embodiment of the present disclosure also provides a method for updating a device mapping table. FIG. 3 is a flowchart of a method for updating a device mapping table according to some embodiments of the present disclosure. The method will be described in detail below.

310, creating a device mapping table representing the mapping relationship, the device mapping table being used to record data format information and MPU dimensions for the GPUs of different specifications.

Table 1 is an example device mapping table. The architectural characteristics of the target GPU (e.g., the size of MPUs and cache blocks sizes) can provide a data reference for the KVCache to perform data partition and redistribution.

| | | | Cache | Memory | Supported | | |
|---|---|---|---|---|---|---|---|
| | | | Block | Alignment | Floating- | Optimal | |
| | | | Size | Requirement | Point | Block | |
| GPU Model | Manufacturer | MPU Dimension | (Byte) | (Byte) | Precision | Size | Note |
| N A100 | N | 16 × 16 (tensor | 128 | 32 | FP16 | 32 × 32 | High throughput, |
| | | core) | | | FP32 | | optimized for FP16 |
| | | | | | BF16 | | |
| N H100 | N | 32 × 32 (tensor | 256 | 64 | FP8 | 64 × 64 | Supports FP8 and ultra- |
| | | core) | | | FP16 | | high bandwidth |
| | | | | | FP32 | | |
| A MI250 | A | 32 × 32 (matrix | 256 | 128 | FP16 | 64 × 64 | High matrix computing |
| | | core) | | | FP32 | | efficiency |
| A MI100 | A | 16 × 16 (matrix | 128 | 64 | FP16 | 32 × 32 | Mid-range computing, |
| | | core) | | | FP32 | | balanced performance |
| I Ponte Vecchio | I | 8 × 8 (Xe atrix) | 64 | 32 | FP16 | 16 × 16 | Suitable for small-scale |
| | | | | | FP32 | | matrix operations |
| Default (General | N/A | N/A | 64 | 32 | FP32 | 32 × 32 | Fallback for |
| Configuration) | | | | | | | unrecognized hardware |

In some embodiments, the optimal blocking strategy and computation layout can be selected by querying table entries (e.g., Table 1) based on the target GPU type. In addition, the system supports the dynamic updating of mapping tables to accommodate new hardware.

320, when it is determined that the data format information and the MPU dimensions of the target GPU are absent from the device mapping table, adding the data format information and the MPU dimensions of the target GPU to the device mapping table

The GPU device mapping table (e.g., Table 1) can be dynamically maintained. In this way, the device mapping table includes key parameters of target GPUs (such as the tensor core dimensions of Vendor N's A100, or the matrix core throughput of Vendor A).

In some embodiments, when a new GPU needs to be processed, whether its data format information and MPU dimensions already exist in the device mapping table can be confirmed. If the data format information and MPU dimensions are absent from the device mapping table, the data format information and MPU dimensions of the new GPU can be added to the device mapping table. When it is determined that the device mapping table does not contain the model of the target GPU corresponding to the data conversion to be executed, after the data format information and the MPU dimensions of the target GPU are obtained, the data format information and MPU dimensions for the specific model of target GPU can be added to the device mapping table.

Consistent with the present disclosure, a device mapping table representing the mapping relationship is created. The device mapping table is used to record data format information and MPU dimensions for GPUs of varying specifications. When it is determined that data format information and MPU dimensions for the target GPU do not exist in the device mapping table, the data format information and MPU dimensions for the target GPU are added to the device mapping table. In this way, the device mapping table remains updated with the latest GPU information, thereby providing accurate mapping relationships for the GPU's data formats and MPU dimensions.

In some embodiments, after the process at 120, the converted key-value cache data may be loaded into the video memory of the target GPU by performing the following processes.

130, encoding the target key-value cache data based on a preset encoding format to obtain an encoded target key-value cache data.

In some embodiments, the encoding format may be pre-configured based on the specific usage scenario. For example, the encoding format may be set to a binary format (e.g., MessagePack), which is suitable for scenarios requiring efficient transmission and storage. Alternatively, the encoding format may be set to a text-based format (e.g., JSON), which is suitable for scenarios requiring readability and compatibility. Further, the encoding format may be set to custom formats to suit specific needs.

In some embodiments, the target key-value cache data may be encoded based on a pre-configured encoding format.

140, loading the encoded target key-value cache data into the video memory of the target GPU.

In some embodiments, video memory may be allocated based on the programming interface of the target GPU. The data blocks and metadata may be encoded into a standard format, such as contiguous NumPy arrays or custom binary streams, and stored in host memory. Subsequently, the encoded target key-value cache data may be loaded from the host memory into the target GPU's video memory.

Consistent with the present disclosure, the target key-value cache data is encoded based on a preset encoding format to obtain the encoded target key-value cache data; then, the encoded target key-value cache data is loaded into the video memory of the target GPU. In this way, the data blocks and metadata are encoded into a standard format and stored in the host memory. This process does not rely on any GPU memory pointers or programming interfaces, thereby ensuring that data can be parsed and reconstructed on any device.

In some embodiments, the target key-value cache data may include at least one target sub-key-value cache data obtained through partitioning, and metadata corresponding to each target sub-key-value cache data. The metadata may at least include location information of the target sub-key-value cache data.

In some embodiments, loading the encoded target key-value cache data into the video memory of the target GPU may be implemented by loading the encoded target key-value cached data into the video memory of the target GPU based on the location information of each target sub-key-value cache data.

During the implementation of loading the target key-value cache data into the video memory of the target GPU, when allocating video memory via the GPU's allocation mechanism, the request for space may be based on the total size of the target key-value cache data (e.g., 12 MB). Subsequently, the target sub-key-value cache data may be reconstructed based on the metadata records within the data blocks, ultimately forming the cache tensor corresponding to the complete target key-value cache data, which is then stored in the video memory.

Consistent with the present disclosure, based on the location information of each target sub-key-value cache data, the encoded target key-value cache data is loaded into the video memory of the target GPU. In this way, the target key-value cache data can be efficiently and accurately loaded into the target GPU's video memory, thereby accelerating the GPU's processing of the target key-value cache data.

In some embodiments, encoding the target key-value cache data based on a preset encoding format may be implemented by encoding the target key-value cache data based on a binary or text format.

The binary format (.npy) enables efficient storage and loading, preserving the data's original type and shape. The text format (JSON) offers high readability and is suitable for viewing and debugging.

In some embodiments, whether to use binary or text format to encode the target key-value cache data may be determined based on the specific usage scenario.

Consistent with the present disclosure, the target key-value cache data can be encoded using binary or text format. In this way, based on various usage scenarios, an appropriate encoding scheme can be determined to efficiently encode and store the target key-value cache data, which is subsequently loaded into the target GPU's video memory.

An embodiment of the present disclosure also provides a method for verifying the target key-value cache data.

150, randomly sampling the target key-value cache data to obtain sampled key-value cache data.

In some embodiments, a subset of the target key-value cache data may be randomly sampled from the entire set of target key-value cache data to obtain the sampled key-value cache data. In addition, it is also possible to randomly sample a subset of target key-value cache data from one or more target key-value cache data, for example, by sampling a portion of the subtensor blocks (i.e., block-partitioned target key-value cache data) within a specific target key-value cache data.

160, using the sampled key-value cache data to perform attention computation on the target GPU to obtain an output result.

In some embodiments, random sampling may be performed on the target GPU to execute small-scale attention computations using Formula (1) to simulate the use of target key-value cache data during actual inference.

$$Attention ( Q , K , V ) = softmax ( \frac{Q {K}^{T}}{\sqrt{{d}_{k}}} ) V \qquad Formula ( 1 )$$

where Q is the query tensor for the test input, K and V represent the partitioned target key-value cache data loaded into the target GPU, and dₖ is the head dimension size.

170, comparing the output result against a preset result to determine whether the error exceeds an error threshold.

In some embodiments, the output of the target GPU may be numerically compared with the expected output. This can be achieved by calculating error metrics, such as the mean-square error (MSE) using Formula (2).

$$MSE = \frac{1}{n} \sum {( {y}_{target} - {y}_{expected} )}^{2} \qquad Formula ( 2 )$$

where y_{target} is the output value, and y_{expected} is the expected value.

In some embodiments, the max absolute error may also be calculated as the error metric.

180, performing one or more repair strategies of precision adjustment, boundary padding, and local data reconstruction on the target key-value cache data.

In some embodiments, if MSE exceeds 1e⁻⁵, it may indicate that a bias is present, which triggers the self-repair. The repair strategy may include precision adjustment, boundary padding, and local data reconstruction. Precision adjustment enables the system to meet computational requirements by adjusting the precision of the target key-value cache data. Boundary padding is capable of padding bytes based on the “memory alignment requirements” of the halfword format (HFMT). Local data reconstruction extracts the metadata and data used to store tensors within the intermediate representation storage layer (IRSL), and regenerates or replaces specific local regions within the data, thereby reconstructing the tensor data.

Consistent with the present disclosure, the target key-value cache data is randomly sampled to obtain the sampled key-value cache data; the sampled key-value cache data is used to perform attention calculations on the target GPU to obtain an output result; then, the output result is compared with a preset result. When it is determined that the error exceeds an error threshold, one or more repair strategies of precision adjustment, boundary padding, or local data reconstruction are executed on the target key-value cache data. In this way, a data validation and self-repair mechanism is provided. This mechanism validates the target key-value cache data after conversion, verifying the correctness of the data by executing small-scale attention computations (e.g., processing a single inference step for a batch). If a numerical deviation is detected (e.g., exceeding the mean squared error of 1e⁻⁵), the system can automatically trigger self-repair mechanisms, which include adjusting local data precision, padding missing boundaries, or reverting to a higher-precision intermediate state. This mechanism is applicable for correcting potential errors arising from hardware differences during cross-platform migration.

Data processing in heterogeneous GPU environments faces the issue of differences in hardware architecture, resulting in data incompatibility. Heterogeneous GPUs exhibit significant disparities in memory alignment, floating-point units, and cache management such that direct data transfer may lead to parsing failures or performance degradation. Further, the lack of uniformity in programming interfaces currently necessitates manual code adjustments or data regeneration, which is a process that is inefficient and difficult to scale. There is also the issue of floating-point precision and computational consistency as unadjusted direct transmission may lead to biased inference results, thereby compromising model accuracy. In addition, there is the issue with distributed inference. In scenarios involving cloud collaboration or cross-vendor GPU load balancing, the demand for cross-platform KVCache transmission is on the rise. For instance, when transferring data from a primary GPU to a heterogeneous secondary GPU to resume inference, there is a lack of a universal adaptation mechanism.

In related technologies, the method for addressing data transfer across heterogeneous GPUs is as follows.

Perform data migration via serialization (e.g., converting data to NumPy arrays or ONNX format). However, this approach introduces additional serialization and deserialization overhead and fails to fully leverage hardware capabilities.

Manually rewrite the data processing logic for the target hardware. However, this approach lacks generality and is unable to adapt to the rapidly iterating GPU hardware ecosystem. It fails to fundamentally resolve the issues of efficient transmission and compatibility regarding key-value cache data within heterogeneous environments.

To address the issues of data processing in heterogeneous GPU environments, embodiments of the present disclosure provide an adaptive method for key-value cache data conversion and transmission in heterogeneous GPU environments, aiming to resolve the compatibility and efficiency issues associated with key-value cache data transmission within such environments. The method involves key technologies such as a dynamic format adaptive engine; data relay, splitting, and encapsulation; GPU hardware feature mapping; and a data validation and self-repair mechanism.

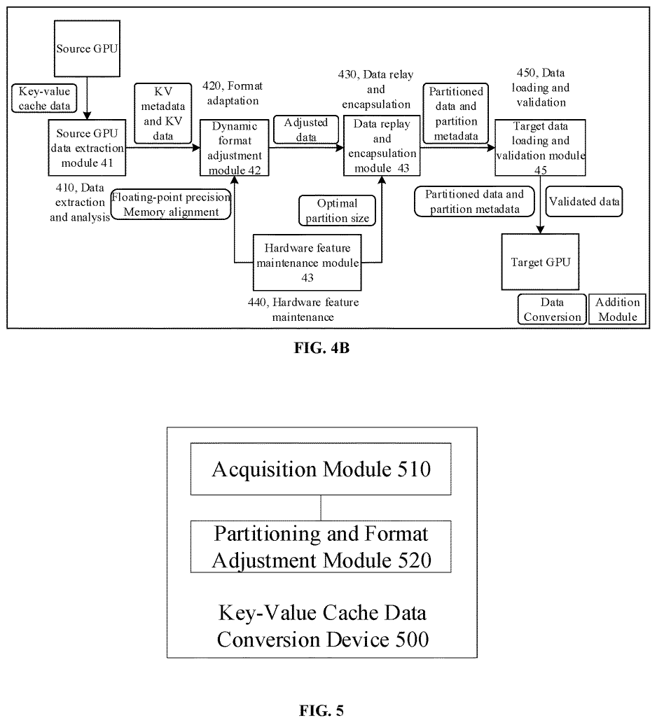

FIG. 4A is a schematic diagram of a newly added module for data conversion according to some embodiments of the present disclosure. As shown in FIG. 4A, the newly added module includes a source GPU data extraction module 41, a dynamic format adjustment module 42, a data relay and encapsulation module 43, a hardware feature maintenance module 44, and a target data loading and validation module 45.

In some embodiments, the source GPU data extraction module 41 may be configured to extract the key-value cache data and record its original metadata, including tensor dimensions ([batch_size, num_heads, seq_len, head_dim]), data type (FP16/FP32), and the hardware context at the time of generation (such as CUDA version and thread block configuration).

In some embodiments, the dynamic format adjustment module 42 may be configured to analyze the hardware differences between the source GPU and the target GPU based on data references provided by the hardware feature maintenance module 44, and to dynamically adjust the key-value cache data format, including operations such as endianness conversion, floating-point precision adjustment, and memory alignment padding optimization.

In some embodiments, the data relay and encapsulation module 43 may be configured to encode the adjusted key-value cache data into a standardized intermediate representation format, which may include partitioned tensors and metadata descriptions, thereby rendering it hardware-agnostic and facilitating cross-platform transmission. Based on a predefined block size, the KVCache can be partitioned into multiple sub-tensors. At the same time, descriptive information can be generated for each sub-tensor. The descriptive information may include block position and original context. Finally, the partitioned data and metadata can be encoded into a unified binary or text format and saved to host memory or disk.

In some embodiments, the hardware feature maintenance module 44 may be configured to obtain the architectural characteristics of the target GPU (such as the size of the MPU and the cached block) to provide data references to the data relay and encapsulation module on how to perform data partitioning and reallocation for the KV Cache. Table 1 above is an information mapping table provided according to some embodiments of the present disclosure.

In some embodiments, the GPU device mapping table (e.g., Table 1) may be dynamically maintained. This table can include key parameters for target GPUs (such as the tensor core dimensions of vendor N's A100, or the matrix core throughput of vendor A). During system runtime, table entries are queried based on the target GPU type to select the optimal block strategy and computation layout. In addition, the system supports dynamic updating of the mapping table to adapt to new hardware.

In some embodiments, the target data loading and validation module 45 may be configured to load intermediate representation data into the target GPU's video memory; allocate the video memory based on the programming interface of the target GPU, and reconstruct the partitioned data received from the data relay and encapsulation module into complete tensors, and load the complete tensors them into the memory. At the same time, by executing the following steps, the integrity of key-value cache data can be validated and corrected through a combination of incremental validation and self-repair mechanisms.

Step 1, randomly sample the target GPU to execute small-scale attention computations using the Formula (1) to simulate the usage of the KVCache during actual inference.

$$Attention ( Q , K , V ) = softmax ( \frac{Q {K}^{T}}{\sqrt{{d}_{k}}} ) V \qquad Formula ( 1 )$$

where Q is the query tensor for the test input, K and V represent the partitioned target key-value cache data loaded into the target GPU, and dₖ is the head dimension size.

Step 2, comparing the output value of the target GPU with the expected output value. This can be achieved by calculating error metrics, such as the mean-square error (MSE) using Formula (2).

$$MSE = \frac{1}{n} \sum {( {y}_{target} - {y}_{expected} )}^{2} \qquad Formula ( 2 )$$

where y_{target} is the output value, and y_{expected} is the expected value.

In some embodiments, the max absolute error may also be calculated as the error metric.

Step 3, if MSE exceeds 1e⁻⁵, it may indicate that a bias is present, which triggers the self-repair. The repair strategy may include precision adjustment, boundary padding, and local data reconstruction. Precision adjustment enables the system to meet computational requirements by adjusting the precision of the target key-value cache data. Boundary padding is capable of padding bytes based on the “memory alignment requirements” of the halfword format (HFMT). Local data reconstruction extracts the metadata and data used to store tensors within the intermediate representation storage layer (IRSL), and regenerates or replaces specific local regions within the data, thereby reconstructing the tensor data.

FIG. 4B is a flowchart of the key-value cache data conversion method according to some embodiments of the present disclosure. The method will be described in detail below.

410, data extraction and analysis.

In some embodiments, the source GPU data extraction module 41 may be configured to obtain and analyzes the key-value cache data from the source GPU. The source GPU data extraction module 41 may first detect hardware characteristics (such as model, memory capacity, and floating-point precision), then extract tensors from the video memory (e.g., an FP16 tensor with the shape [4, 12, 1024, 64], approximately 12 MB in size), and finally generate metadata (including hardware context information such as dimensions, data types, and endianness). Subsequently, the data may be copied to the host memory to ensure that subsequent processing is based on accurate source data and metadata, thereby avoiding adaptation issues caused by omissions related to hardware characteristics.

420, format adaptation.

In some embodiments, the dynamic format adjustment module 42 may be configured to obtain the key-value cache data and metadata from the source GPU data extraction module 41, and adjustment them to a format suitable for the target GPU. Based on the GPU hardware feature data maintained by the hardware feature maintenance module 44, the hardware features of the target GPU may be detected, for example, by obtaining the supported floating-point precision (FP32) and memory alignment requirements (128 bytes). Next, the discrepancies between the source data (FP16, 32-byte aligned) and the target requirements can be analyzed to determine the conversion requirements, such as promoting FP16 to FP32 to align with the MI250's compute units. In addition, data boundaries can be padded to ensure 128-byte alignment, thereby avoiding any loss in memory access efficiency. Following this adjustment, the system can validate whether the data format complies with the target hardware constraints, ensuring compatibility for subsequent transmission and computation.

430, data relay and encapsulation.

In some embodiments, the data relay and encapsulation module 43 may be configured to obtain the key-value cache data adjusted by the dynamic format adjustment module 42 and, based on the optimal block size provided by the hardware feature maintenance module 44, generate a hardware-agnostic intermediate data representation. That is, the tensor can be partitioned into blocks of a specific size (e.g., 64×64), for example, by decomposing a tensor of shape [4, 12, 1024, 64] into multiple sub-tensors. Metadata, including the block index, original dimensions, and data type (such as FP32), can be attached to each block to form a logical description. Subsequently, these data partitions and metadata can be encoded into a standard format, such as contiguous NumPy arrays or custom binary streams, and stored in host memory. As described above, this process relies on neither GPU device pointers nor programming interfaces, thereby ensuring that the data can be parsed and reconstructed on any device.

440, hardware feature maintenance.

In some embodiments, the hardware feature maintenance module 44 may be configured to guide the dynamic format adjustment module 42 and the data relay and encapsulation module 43 to perform adjustments and optimizations based on the hardware features of the target GPU. First, the mapping table maintained by the hardware feature maintenance module (e.g., Table 1) may be queried. For example, the entry for vendor A's MI250 indicates the size of the MPU is 32×32, an optimal block size is 64×64, and the cache block size is 256 bytes. If the partition of the intermediate representation (e.g., 64×64) aligns with the recommended value, it may remain unchanged; otherwise, it may be adjusted to a more optimal layout (e.g., transitioning from 32×32 to 64×64) to match the computational efficiency of the matrix core. In addition, data boundaries may be padded based on the “memory alignment requirements” (128 bytes) to ensure the cache hit rates during loading. Upon completion of the optimization, the system can validate whether the blocks are aligned with the target GPU's hardware acceleration units.

450, data loading and validation.

In some embodiments, the target data loading and validation module 45 may be configured to obtain the partitioned data optimized by the data relay and encapsulation module 43 and load it into the target GPU's memory, perform memory allocation using the target GPU's video allocation scheme, and request the space based on the total size of the key-value cache data (e.g., 12 MB). Subsequently, the entire key-value cache data may be reconstructed based on the metadata records within the data blocks, ultimately forming a complete key-value cache data tensor, which can be stored in the video memory of the GPU.

In some embodiments, the target data loading and validation module 45 may validate the correctness of key-value cache data through validations and self-repair mechanisms. That is, perform a small-scale attention computation to compare the output against the expected result. If the error is greater than (e.g., MSE greater than 1e⁻⁵) the threshold, a self-repair mechanism may be triggered. After the repair, a re-validation can be performed to ensure data usability. Through automated validation and repair, this process ensures the reliability of the key-value cache data in heterogeneous environments.

Embodiments of the present disclosure provide an adaptive method for key-value cache data conversion and transmission in a heterogeneous GPU environment. The method aims to address compatibility and efficiency issues associated with key-value cache data transmission within a heterogeneous GPU environment. The method includes four key technologies, namely a dynamic format adaptive engine, data relay, splitting, and encapsulation, GPU hardware feature mapping, and a data validation and self-repair mechanism. The dynamic format adaptive engine may be configured to, prior to data transmission, automatically adjusts the key-value cache data format, including precision enhancement (promoting FP16 to FP32) endianness conversion, and boundary padding (e.g., 128 bytes) through real-time detection of the hardware features, such as endianness, floating-point precision, and memory alignment, of both the source GPU (e.g., vendor N's A100, FP16, little-endian) and the target GPU (e.g., vendor A's MI250, FP32, big-endian). Data relay, splitting, and encapsulation is the process that converts the key-value cache data into a hardware-agnostic intermediate representation. That is, partitioning tensors into sub-tensors of a fixed size (e.g., 64×64) and attaching metadata (such as block indices, dimensions, and data types) to achieve standardization and decoupling. For example, a 1024×1024 tensor can be partitioned into 256 blocks of 64×64, and metadata can be attached to each block. The locations of the metadata can be recorded to facilitate data reconstruction. This approach does not rely on the underlying implementation details of a specific GPU (such as video memory pointers); instead, it requires processing only generic logical data structures, thereby eliminating dependency on the source GPU hardware. In GPU hardware feature mapping, a mapping table is used to maintain the GPU features by recording key parameters for various GPU architectures. During the transfer of key-value cache data, the system can optimize data partitioning and computation layout based on the features of the target GPU. For example, if the MPUs of the target GPU favor 32×32 blocks, the mapping table can be used to guide the data relay, splitting and encapsulation processes to adjust block sizes to match the hardware acceleration units, thereby enhancing inference performance. In addition, the mapping table can support dynamic updates to facilitate adaptation to new types of hardware. The validation and self-repair mechanism may be configured to validate the converted key-value cache data on the target GPU or the intermediate processing device by executing small-scale attention computations (e.g., processing a single batch of single-step inference) to validate the correctness of the data. If a numerical deviation is detected (e.g., exceeding the mean squared error of 1e⁻⁵), the system can automatically trigger self-repair mechanisms, including readjusting local data precision, padding the missing boundaries, or reverting to a higher-precision intermediate representation. This mechanism is applicable for correcting potential errors arising from hardware differences during cross-platform migration.

Based on the foregoing embodiments, an embodiment of the present disclosure provides a key-value cache data conversion device. The device includes multiple modules, each module includes various sub-modules, and each sub-module includes various units. These components may be implemented via a processor within an electronic device, or, alternatively, through specific logic circuits. In some embodiments, the processor may be a central processing unit (CPU), a microprocessor unit (MPU), a digital signal processor (DSP), a field-programmable gate array (FPGA), etc.

FIG. 5 is a schematic diagram of a key-value cache data conversion device 500 according to some embodiments of the present disclosure. As shown in FIG. 5, the device 500 includes an acquisition module 510 and a partitioning and format adjustment module 520.

In some embodiments, the acquisition module 510 may be configured to obtain the source key-value cache data extract from the source GPU.

In some embodiments, the partitioning and format adjustment module 520 may be configured to perform partitioning and data format adjustment on the source key-value cache data based on the mapping information between the source GPU and the target GPU to obtain the target key-value cache data that matches the processing capabilities of the target GPU.

In some embodiments, the mapping information may include the data format information and the matrix processing unit dimensions.

In some embodiments, the partitioning and format adjustment module 520 may include a first format adjustment sub-module and a first partitioning sub-module. The first format adjustment sub-module may be configured to adjust the source key-value cache data based on the data format of the target GPU to obtain first key-value cache data. The first partitioning sub-module may be configured to partition the said first key-value cache data based on the block partitioning rules to obtain the said target key-value cache data. In some embodiments, the block partitioning rules may be determined based on the dimensions of the MPU of the target GPU.

In some embodiments, the partitioning and format adjustment module 520 may also include a second partitioning sub-module and a second format adjustment sub-module. The second partitioning sub-module may be configured to partition the source key-value cache data based on block partitioning rules to obtain second key-value cache data. In some embodiments, the block partitioning rules may be determined based on the dimensions of the MPU of the target GPU. The second format adjustment sub-module may be configured to adjust the second key-value cache data based on the data format of the target GPU to obtain the target key-value cache data.

In some embodiments, the data format information may include at least one of: endianness, floating-point precision, and memory alignment.

In some embodiments, the key-value cache data conversion device may also include a creation module and an update module. The creation module may be configured to generate a device mapping table representing the mapping relationship, and record data format information and matrix operation unit dimensions for GPUs of various specifications. The update module may be configured to, when the data format information and matrix operation unit dimensions of the target GPU are determined to be absent from the device mapping table, add and record the data format information and matrix operation unit dimensions of the target GPU into the device mapping table.

In some embodiments, the key-value cache data conversion device may also include an encoding module and a loading module. The encoding module may be configured to encode the target key-value cache data based on a preset encoding format to obtain the encoded target key-value cache data. The loading module may be configured to load the encoded target key-value cache data into the video memory of the target GPU.

In some embodiments, the target key-value cache data may include at least one target sub-key-value cache data obtained through partitioning, and metadata corresponding to each target sub-key-value cache data. The metadata may at least include location information of the target sub-key-value cache data. In some embodiments, the loading module may be further configured to load the encoded target key-value cache data into the video memory of the target GPU based on the location information of each target sub-key-value cache data.

In some embodiments, the encoding module may be further configured to encode the target key-value cache data based on a binary for text format.

In some embodiments, the key-value cache data conversion device may also include a random sampling module, an attention computation module, a comparison module, and a repair module. The random sampling module may be configured to randomly sample the target key-value cache data to obtain sampled key-value cache data. The attention computation module may be configured to perform attention computation on the target GPU using the sampled key-value cache data to obtain an output result. The comparison module may be configured to compare the output result with a preset result and determine whether the error exceeds an error threshold. The repair module may be configured to perform at least one of the following repair strategies on the target key-value cached data: precision adjustment, boundary padding, and local data reconstruction.

It should be noted here that the descriptions of the above device embodiments are similar to the description of the above method embodiments. The device embodiments have similar advantageous effects with those of the method embodiments and thus the description thereof will be omitted here. For those technical details not mentioned in the above device embodiments, reference can be made to the description of the above method embodiments and the description thereof will be omitted here for simplicity.

It should be noted that, in the embodiments of the present disclosure, if the above method is realized in the form of software function units and are sold or used as independent products, the display method can be stored in a computer-readable storage medium. On the basis of such an understanding, the technical solution of the present disclosure, in essence, encompasses all or a part of the technical solution which contributes to the conventional technology in the form of software products, which may be stored in a storage medium, including instructions to cause an electronic device (e.g., a mobile phone, a tablet computer, a notebook computer, a desktop computer, or the like) to execute the entire or a part of method consistent with the disclosure, such as one of the example methods described above. The aforementioned storage medium may include but is not limited to a medium that can store program codes, such as a universal serial bus (USB) flash drive, a read-only memory (ROM), a random-access memory (RAM), a portable hard disk, a magnetic disk or an optical disk. The embodiments of the present disclosure are not limited to any specific combination of hardware and software.

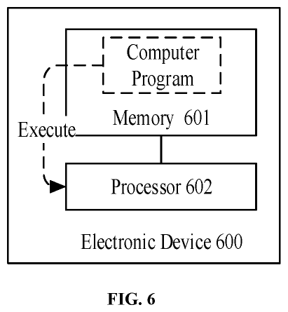

An embodiment of the present disclosure provides an electronic device. FIG. 6 is a schematic diagram of an electronic device 600 according to some embodiments of the present disclosure. As shown in FIG. 6, the electronic device 600 includes a memory 601 and a processor 602. The memory 601 stores a computer program executable on the processor 602. When executing the computer program, the processor 602 performs the steps of the key-value cache data conversion method provided in the foregoing embodiments.

The memory 601 may be configured to store instructions and applications executable by the processor 602, and also cache the to-be-processed or processed data (e.g., image data, audio data, voice communication data, and video communication data) processed by the processor 602 and various modules in the electronic device, which can be implemented by a flash memory or a random-access memory.

It should be noted here that the descriptions of the above storage medium and electronic device embodiments are similar to the description of the above method embodiments. The storage medium and electronic device embodiments have similar advantageous effects with those of the method embodiments and thus the description thereof will be omitted here. For those technical details not mentioned in the above storage medium and electronic device embodiments, reference can be made to the description of the above method embodiments and the description thereof will be omitted here for simplicity.

It is to be noted that the term “one embodiment” or “an embodiment” as used throughout the description means that the specific features, structures or characteristics associated with the embodiment are included in at least one embodiment of the present disclosure. Hence, the expression “in one embodiment” or “in an embodiment” as used throughout the description does not necessarily refer to the same embodiment. Further, these specific features, structures or characteristics can be arbitrarily combined in one or more embodiments as appropriate. It should be appreciated that, in various embodiments of the present disclosure, the numbering of the above processes does not mean the order in which they are executed. The order in which the processes are executed should be determined by their functions and internal logics, rather than being limited to any embodiment of the present disclosure. The numbering of the above embodiments is used for the purpose of illustration only, but does not imply any preference among those embodiments.

It is to be noted here that the terms “including” or “comprising” or any variants thereof as used herein are not exclusive, such that a process, method, article or apparatus including/comprising a number of elements may also include/comprise other elements that are not explicitly listed or inherent to the process, method, article or apparatus. If not limited otherwise, an element included in process, method, article or apparatus does not exclude a situation where the process, method, article or apparatus including the element further includes one or more identical elements.

It can be appreciated from the embodiments of the present disclosure that the disclosed method and device can be implemented in alternative ways. The device embodiments described above are illustrative only. For example, while the units have been divided in accordance with their logical functions, other divisions are possible in practice. For example, more than one unit or element can be combined or can be integrated into another system, or some features can be ignored or omitted. In addition, the coupling, direct coupling or communicative connection between various components as shown or discussed can be an indirect coupling or communicative connection via some interface, device or unit and can be electrical, mechanical or in another form.

The units described above as separated may or may not be physically separated. The components shown as units may or may not be physical units. They can be co-located or can be distributed over a number of network elements. Depending on actual requirements, some or all of the units can be selected to achieve the object of the present disclosure.

Further, all the functional units in various embodiments of the present disclosure can be integrated within one processing unit, or each of these units can be a separate unit, or two or more units can be integrated into one unit. Such integrated unit can be implemented in hardware, possibly in combination with software functional units.

It can be appreciated by those skilled in the art that some or all of the steps in the method embodiments described above can be implemented by hardware following instructions of a program. Such program can be stored in a computer readable storage medium and, when executed, performs the steps of the above method embodiments. The storage medium may be any of various mediums capable of storing program codes, such as a mobile storage device, a read-only memory (ROM), a random-access Memory (RAM), a magnetic disk or an optical disc.

Alternatively, when the above integrated units of the present disclosure are implemented in software functional modules and sold or used as a standalone product, they can be stored in a computer readable storage medium. In view of this, the technical solutions according to the embodiments of the present disclosure, or in other words a part thereof which makes contribution over the prior art, can be substantially embodied in a form of software product. The computer software product can be stored in a storage medium, such as ROM/RAM, magnetic disk, optical disc and the like, containing instructions which cause an electronic device (which can be a mobile phone, a tablet computer, a notebook computer, a desktop computer or the like) to perform one or more methods according to the embodiments of the present disclosure or particular parts thereof. The storage medium may be any of various mediums capable of storing program codes, such as a mobile storage device, a ROM, a RAM, a magnetic disk or an optical disc.

The methods disclosed in the method embodiments of the present disclosure may be arbitrarily combined without conflict to obtain new method embodiments.

The features disclosed in the product embodiments of the present disclosure may be combined arbitrarily without conflicts to obtain new product embodiments.

The features disclosed in the method or device embodiments of the present disclosure may be combined arbitrarily without conflict to obtain new method embodiments or device embodiments.

The above are merely some embodiments of the present disclosure. The scope of the present disclosure is not limited to this. Those skilled in the art can easily think of variations or replacements within the scope of the present disclosure. These variations or replacements should be within the scope of the present disclosure.

What is claimed is:

1. A key-value cache data conversion method comprising:
obtaining source key-value cache data extracted from a source graphics processing unit (GPU); and
partitioning and adjusting data format of the source key-value cache data based on mapping information between the source GPU and a target GPU to obtain target key-value cache data that matches processing capability of the target GPU.

2. The method of claim 1, wherein:
the mapping information includes data format information and matrix processing unit (MPU) dimensions; and,
partitioning and adjusting data format of the source key-value cache data based on the mapping information between the source GPU and the target GPU to obtain the target key-value cache data that matches the processing capability of the target GPU includes:
adjusting the source key-value cache data based on the data format of the target GPU to obtain first key-value cache data; and
partitioning the first key-value cache data based on block partitioning rules to obtain the target key-value cache data, the block partitioning rules being determined based on the dimensions of the MPU of the target GPU.

3. The method of claim 2, wherein partitioning and adjusting data format of the source key-value cache data based on the mapping information between the source GPU and the target GPU to obtain the target key-value cache data that matches the processing capability of the target GPU includes:
partitioning the source key-value cache data based on the block partitioning rules to obtain second key-value cache data, the block partitioning rules being determined based on the dimensions of the MPU of the target GPU; and
adjusting the second key-value cache data based on the data format of the target GPU to obtain the target key-value cache data.

4. The method of claim 2, wherein:
the data format information includes one or more of endianness, floating-point precision, and memory alignment.

5. The method of claim 2 further comprising:
creating a device mapping table representing mapping relationships, the device mapping table being used to record data format information and MPU dimensions for GPUs of different specifications; and
adding the data format information and MPU dimensions of the target GPU into the device mapping table when it is determined that the data format information and MPU dimensions are absent from the device mapping table.

6. The method of claim 1, further comprising:
encoding the target key-value cache data based on a preset encoding format to obtain encoded target key-value cache data; and
loading the encoded target key-value cache data into a video memory of the target GPU.

7. The method of claim 6, wherein the target key-value cache data includes at least one target sub-key-value cache data obtaining through partitioning, and metadata corresponding to each target sub-key-value cache data, the metadata at least including location information of the target sub-key-value cache data; and
loading the encoded target key-value cache data into the video memory of the target GPU includes:
loading the encoded target key-value cache data into the video memory of the target GPU based on the location information of each of the target sub-key-value cache data.

8. The method of claim 1, further comprising:
randomly sampling the target key-value cache data to obtain sampled key-value cache data;
performing attention computation using the sampled key-value cache data on the target GPU to obtain an output result;
comparing the output result with a preset result to determine whether an error exceeds an error threshold; and
performing one or more repair strategies of precision adjustment, boundary padding, and local data reconstruction, on the target key-value cache data.

9. An electronic device including one or more processors and a memory storing one or more computer program instructions, when executed by the one of more processors, the computer program instructions implementing a key-value cache data conversion method, the method comprising:
obtaining source key-value cache data extracted from a source graphics processing unit (GPU); and
partitioning and adjusting data format of the source key-value cache data based on mapping information between the source GPU and a target GPU to obtain target key-value cache data that matches processing capability of the target GPU.

10. The electronic device of claim 9, wherein:
the mapping information includes data format information and matrix processing unit (MPU) dimensions; and,
partitioning and adjusting data format of the source key-value cache data based on the mapping information between the source GPU and the target GPU to obtain the target key-value cache data that matches the processing capability of the target GPU includes:
adjusting the source key-value cache data based on the data format of the target GPU to obtain first key-value cache data; and
partitioning the first key-value cache data based on block partitioning rules to obtain the target key-value cache data, the block partitioning rules being determined based on the dimensions of the MPU of the target GPU.

11. The electronic device of claim 10, wherein partitioning and adjusting data format of the source key-value cache data based on the mapping information between the source GPU and the target GPU to obtain the target key-value cache data that matches the processing capability of the target GPU includes:
partitioning the source key-value cache data based on the block partitioning rules to obtain second key-value cache data, the block partitioning rules being determined based on the dimensions of the MPU of the target GPU; and
adjusting the second key-value cache data based on the data format of the target GPU to obtain the target key-value cache data.

12. The electronic device of claim 10, wherein:
the data format information includes one or more of endianness, floating-point precision, and memory alignment.

13. The electronic device of claim 10, the key-value cache data conversion method further comprising:
creating a device mapping table representing mapping relationships, the device mapping table being used to record data format information and MPU dimensions for GPUs of different specifications; and
adding the data format information and MPU dimensions of the target GPU into the device mapping table when it is determined that the data format information and MPU dimensions are absent from the device mapping table.

14. The electronic device of claim 10, the key-value cache data conversion method further comprising:
encoding the target key-value cache data based on a preset encoding format to obtain encoded target key-value cache data; and
loading the encoded target key-value cache data into a video memory of the target GPU.

15. The electronic device of claim 13, wherein:
the target key-value cache data includes at least one target sub-key-value cache data obtaining through partitioning, and metadata corresponding to each target sub-key-value cache data, the metadata at least including location information of the target sub-key-value cache data; and
loading the encoded target key-value cache data into the video memory of the target GPU includes:
loading the encoded target key-value cache data into the video memory of the target GPU based on the location information of each of the target sub-key-value cache data.

16. The electronic device of claim 13, wherein the method further includes:
randomly sampling the target key-value cache data to obtain sampled key-value cache data;
performing attention computation using the sampled key-value cache data on the target GPU to obtain an output result;
comparing the output result with a preset result to determine whether an error exceeds an error threshold; and
performing one or more repair strategies of precision adjustment, boundary padding, and local data reconstruction on the target key-value cache data.

17. Non-transitory computer readable storage medium storing one or more computer programs, when executed by one or more processors, the computer program implementing a key-value cache data conversion method comprising:
obtaining source key-value cache data extracted from a source graphics processing unit (GPU); and
partitioning and adjusting data format of the source key-value cache data based on mapping information between the source GPU and a target GPU to obtain target key-value cache data that matches processing capability of the target GPU.

18. The computer readable storage medium of claim 17, wherein: the mapping information includes data format information and matrix processing unit (MPU) dimensions; and,
partitioning and adjusting data format of the source key-value cache data based on the mapping information between the source GPU and the target GPU to obtain the target key-value cache data that matches the processing capability of the target GPU includes:
adjusting the source key-value cache data based on the data format of the target GPU to obtain first key-value cache data; and
partitioning the first key-value cache data based on block partitioning rules to obtain the target key-value cache data, the block partitioning rules being determined based on the dimensions of the MPU of the target GPU.

19. The computer readable storage medium of claim 18, wherein partitioning and adjusting data format of the source key-value cache data based on the mapping information between the source GPU and the target GPU to obtain the target key-value cache data that matches the processing capability of the target GPU includes:
partitioning the source key-value cache data based on the block partitioning rules to obtain second key-value cache data, the block partitioning rules being determined based on the dimensions of the MPU of the target GPU; and
adjusting the second key-value cache data based on the data format of the target GPU to obtain the target key-value cache data.

20. The computer readable storage medium of claim 18, wherein:
the data format information includes one or more of endianness, floating-point precision, and memory alignment.
